(19) United States
(12) Patent Application Publication
(10) Pub. No.: US 2006/0029359 A1
(43) Pub. Date: Feb. 9, 2006

(54) Broadcast receiving apparatus and information reproducing method therefor

(76) Inventors: Takekazu Shigehara, Yokohama (JP); Sadao Tsuruga, Yokohama (JP); Takashi Kanemaru, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/194,525

(22) Filed: Aug. 2, 2005

(30) Foreign Application Priority Data
Aug. 3, 2004 (JP) 2004-226458

(51) Int. Cl. H04N 5/76

(52) U.S. Cl. 386/46; 386/83

(57) ABSTRACT

A broadcast receiving apparatus and an information reproducing method for it, enabling to provide “slow playback” of video/audio stream data, actually, including voices therein, comprises the flowing components, for example, a tuner portion (161, 120) for receiving a program broadcasted; a recording medium, i.e., HDD (300), for recording a signal from the tuner portion, after converting it into a predetermined format; and a display portion (200) for displaying a video/audio signal from the tuner portion or the HDD, and further, wherein the video/audio signal of the broadcasting program is reproduced at a speed, being lower than a speed when conducting a normal reproduction thereon and further being set within an allowable setup region of causing no trouble in reproduction of an audio, which is set in advance, when reproducing the video/audio signal to be outputted.

### BACKGROUND OF THE INVENTION

The present invention relates to an apparatus and a method thereof, for dealing with AV (Audio/Video) contents being transmitted through broadcastings, including those of a digital method and an analog method, etc., and in particular, it relates to a broadcast receiving apparatus, enabling video recording onto an information recording medium, such as, a build-in type HDD (Hard Disk Drive), etc., for example, about the programs of the broadcasting, as well as, an information reproducing method for it.

In recent years, in addition to the conventional television broadcasting of an analog method, television broadcastings are also spreading widely, through broadcasting by means of a broadcasting satellite and/or a communication satellite, and further in terrestrial broadcastings through ground waves; therefore, a system for receiving various kinds of broadcasting is widely spreading, even within an ordinary family. Further, within such the system, since it is possible to ensure a large number of channels, comparing to the case of only the conventional analog broadcasting, therefore the broadcasting is made on an extremely large number of the channels. Also, at the same time, for the purpose of recoding/reproducing such a large number of broadcasting programs, various kinds of AV equipment and/or apparatuses are commercialized on markets, one by one, for example, a digital VTR, a disk recorder, etc.

Also in the latest years, accompanying with the high-speed of information transmission, there is achieved a stream recording/reproducing apparatus, i.e., being called by a “HDD recorder”, which installs therein an information recording medium of a large capacity, such as, a hard disk drive (i.e., HDD), for example; thereby, enabling to recording/reproducing of the video/audio stream data with using that HDD, while receiving a large number of those channels.

On the other hand, there is also known a single television apparatus, having a video data holding portion by itself, for recording the real-time frames therein, temporarily, by a plural number of the frames, at distance of a predetermined number of the frames, so as to display a slow picture and/or a pause picture, or a feed forward picture of them, etc.; thereby enabling to reproduce that data stored in the video data holding portion, repetitively, on a single body of the television receiver, for example, in Japanese Patent Laying-Open No. Hei 7-336616 (1995).

### SUMMARY OF THE INVENTION

By the way, with such the stream recording/reproducing apparatus as was mentioned above, there is prepared or provided a function, such as, a “time shift” for example, with using the functions of the hard disk drive (or, HDD), i.e., the information recording medium of a large capacity thereof, which is built within the apparatus. Herein, the “time shift” is a function for enabling a viewer to leave her/his seat, during observation or watching on a sports program, etc., for example, due to any reason, but without losing the sight of the pictures during that period, and in more details thereof, the video/audio stream data of the program on the air is recorded onto the HDD, once, and thereafter, the recorded data is reproduced to be displayed on the screen, after the viewer turns back to her/his seat, again, for example.

However, with the stream recording/reproducing apparatus installing therein such the information-recording medium of large capacity (i.e., the HDD) mentioned above, using the functions of the HDD, effectively, as well as, achieving such the “time shift” function therewith, as was mentioned above, it is also possible to reproduce the video data recorded within the HDD, extending the time thereof (i.e., a “slow replay or playback”), and thereby enabling to display the picture data in a slow mode.

However, in that instance, when reproducing the vide/audio stream data, including not only the pictures, but also the voices thereof, the audio data is also reproduced, slowly, i.e., extending the time thereof, and therefore, it is hard to hear the voices, in particular, when including conversations, etc., therein. For this reason, with such the stream recording/reproducing apparatus, it is difficult to achieve (or provide) the function of “slow playback” mentioned above. In other words, it is difficult to say that the functions are fully practiced or used, of the information-recording medium of large capacity (i.e., the HDD), which is built within the apparatus, especially, with much effort.

Then, according to the present invention, being achieved by taking the drawbacks of the above-mentioned conventional art into the consideration thereof, and in more particular, an object thereof is to provide a broadcast receiving apparatus, enabling to make recording/reproducing of the video/audio stream data, including not only the pictures, but also the voices thereof, using the information recording medium, which is built within the apparatus, effectively, and also achieving the “slow playback” mentioned above, practically, and to provide an information reproducing method for it, as well.

For accomplishing the object mentioned above, according to the present invention, there is provided a broadcast receiving apparatus, comprising: a tuner portion for receiving a program broadcasted; a receiving signal conversion portion for a signal from said tuner portion into a predetermined format; a recording medium for recording the signal converted by means of said receiving signal conversion portion; and a display portion for displaying a video/audio signal from either one of said tuner portion and said recording medium, whereby receiving the broadcasting program and enabling to record and reproduce the video/audio signal, further comprising, a function portion for reproducing the video/audio signal of said broadcasting program at a speed, being lower than a speed when conducting a normal reproduction thereon and further being set within an allowable setup region of causing no trouble in reproduction of an audio, which is set in advance, when reproducing the video/audio signal to be outputted.

Also, according to the present invention, within the broadcast receiving apparatus as described in the above, it is preferable that, said allowable setup region set in advance is within a region from 0.75 time to 0.85 time, with respect to a speed when conducting the normal reproduction thereon, and further that the speed when reproducing said video/audio signal is set to be 0.8 time of the speed when conducting the normal reproduction thereon. Also therein, it is preferable that said recoding medium is constructed with a hard disk apparatus.

Further, according to the present invention, the broadcast receiving apparatus, as described in the above, preferably, further comprises a means for starting a reproduction function of said video/audio signal of the broadcasting program at a low speed, and further, it is preferable that said means for starting the slow-speed reproduction function is provided in a portion of a main body of said apparatus, or a portion of a body separated from said main body. And, preferably, said display portion includes a screen for displaying the vide signal thereon and a speaker for reproducing the audio signal.

In addition to the above, according to the present invention, also for accomplishing the object mentioned above, there is also provided an information reproducing method for use of a broadcast receiving apparatus, for recoding/reproducing video/audio information of a program, being broadcasted, onto a recording medium of being recordable and reproducible of information, which is built within the apparatus, thereby enabling to reproduce the video/audio information broadcasted, wherein the video/audio signal of said broadcasting program is reproduced at a speed, being lower than a speed when conducting a normal reproduction thereon and further being set within an allowable setup region of causing no trouble in reproduction of an audio, which is set in advance, when reproducing the video/audio signal. Further, in the information reproducing method as described in the above, it is preferable, that said allowable setup region set in advance is within a region from 0.75 time to 0.85 time, with respect to a speed when conducting the normal reproduction thereon, and further that the speed when reproducing said video/audio signal is set to be 0.8 time of the speed when conducting the normal reproduction thereon.

As was mentioned above, with the broadcast receiving apparatus and the information reproducing method for it, according to the present invention, it enables recording/reproducing of the video/audio stream data, including not only the pictures, but also the voices thereof, with using the information recording medium of a large capacity (i.e., the HDD), which is built within the apparatus, and also enables to achieve the “slow playback” mentioned above, practically; thereby, enabling to provide the broadcast receiving apparatus being superior, from a practical viewpoint, and further the information reproducing method for it.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view for showing the circuit structure within a broadcast receiving apparatus, according to an embodiment of the present invention, in particular, for achieving the “slow replay” function;

FIG. 2 is a flowchart for explaining the operations of the “slow playback” function in the broadcast receiving apparatus mentioned above;

FIG. 3 is a view for showing a relationship between a normal playback and the slow playback of the video/audio signals, to the recording of the video/audio signals within the broadcast receiving apparatus mentioned above; and

FIG. 4 is a block diagram for showing the detailed structure within an inside of the broadcast receiving apparatus mentioned above.

### DETAILED DESCRIPTION OF THE PREFERRED EMBODIMENT

Hereinafter, embodiments according to the present invention will be fully explained by referring to the attached drawings.

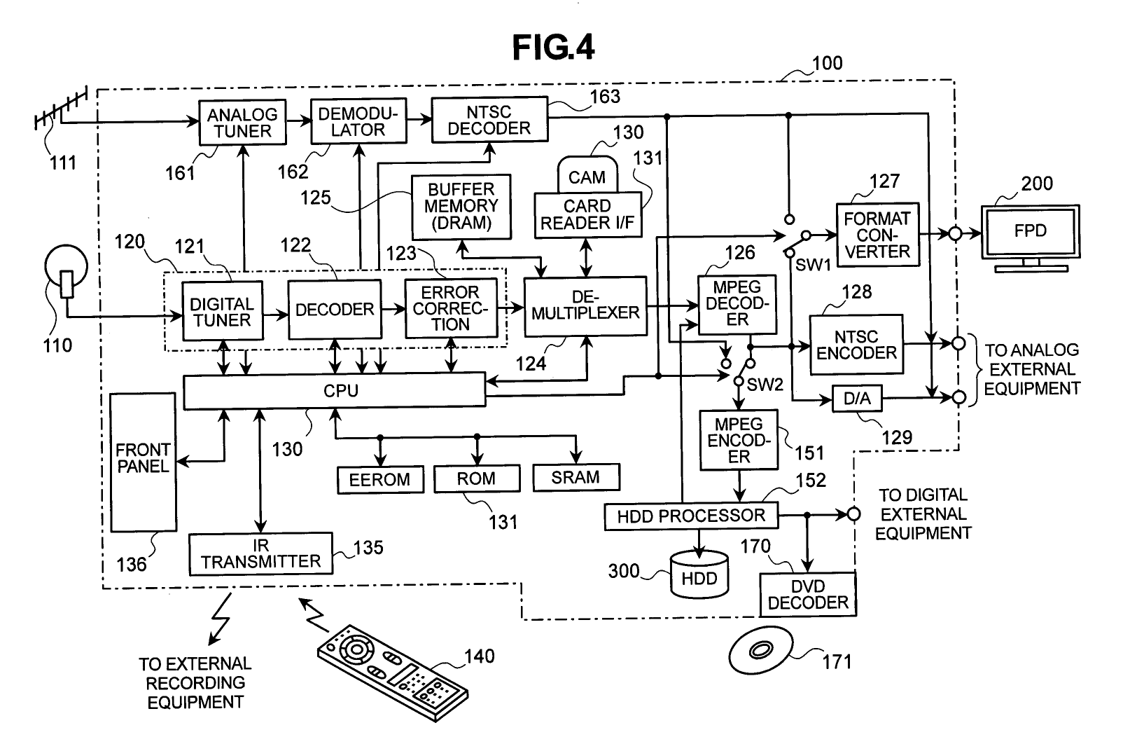

First of all, FIG. 4 attached herewith is a block diagram for showing an example of the structure of a broadcast receiving apparatus, including an information recording medium within an inside thereof, according one embodiment of the present invention, wherein a reference numeral 100 depicts AV equipment (i.e., a broadcast receiving apparatus), receiving digital and analog broadcasting, thereby for displaying contents of that broadcasting (including, a program through the video/audio, a program of data broadcasting, and data through the data broadcasting) on a flat panel display (FPD) 200, such as, a plasma display panel or a liquid crystal panel, etc., including also a speaker therein, for reproducing and outputting voices, for example, in that figure.

In this FIG. 4, a reference numeral 110 depicts a parabola antenna for receiving the digital broadcasting on the air, and a RF signal from this antenna 110 is supplied into a digital tuner 121, building up a tuner module (or a control end) 120 within the digital broadcast receiving apparatus mentioned above, thereby to be decoded thereafter. An output of this digital tuner 121 is supplied to a QPSK decoder circuit 122, for example, which also builds up the tuner module 120, for conducting a QPSK decoding therein. Thereafter, an output of this QPSK decoder circuit 122 is supplied into an error correction circuit 123, which also builds up the tuner module 120 mentioned above, where an error generated during the transmission is detected therein; i.e., conducted the error correction thereon. Thus, this tuner module 120 selects a signal of a channel having a frequency designated, and extracts TS (Transport Stream) from it.

A de-multiplexer 124 inputs a signal, which is outputted from the error correction circuit 123 of the digital tuner module 120 mentioned above, and after recording it into a data buffer memory (such as, a DRAM (Dynamic Random Access Memory) or a SRAM (Static Random Access Memory)) 125, once, and also reads out it, appropriately, so as to decode it, and thereby supplying the video/audio signal decoded to a MPEG decoder 126. Thus, de-multiplexing process within that de-multiplexer 124 is for taking out a necessary stream from the transport stream (TS), on which plural numbers of streams of video and audio are multiplexed within a multiplexing apparatus (MUX) at a transmitter side; in other words, conducting the filtering for taking out the necessary stream from among packets of various kinds of streams. Namely, in case when selecting a certain channel, since a PID (i.e., a packet ID) of the video and/or the audio, building up the service of that channel, is designated within a PMT of that channel, then on a side of a receiver, it is possible to pick up the stream of the video and the audio, and thereby to provide that program.

To the de-multiplexer 124 mentioned above, there is further connected a card reader interface (I/F) 131, into which can be inserted a CAM (Conditional Access Module) 130 that is made from an IC card building a CPU, ROM and RAM, therein, so as to read out a key memorized therein. Thus, in this IC card 130 is stored the necessary key, together with an decoding program thereof; i.e., to conduct a descrambling process, so as to provide a signal transmitted with treated with descrambling, such as, pay TV program, for example. However, herein, that key is read out from the CAM 130 through the card reader I/F 131, to be supplied to the de-multiplexer 124, and thereby the de-multiplexer 124 decodes the signal coded with using that key.

Thereafter, the stream of video and audio, which is picked up in the de-multiplexer 124 is supplied into the MPEG decoder 126, and in this MPEG decoder 126, a decoding process is conducted on the video/audio signal, which is compressed through the MPEG method (in particular, MPEG 2), while recoding the digital signal inputted within the built-in DRAM or the like, appropriately.

And also, the broadcast receiving apparatus 100 further comprises an antenna 111 for receiving analog broadcasting, and further an analog tuner 161, an analog demodulator circuit 162, a NTSC decoder 163, for building up a analog-type tuner module. From this analog tuner module is outputted the video/audio signals of a program broadcasted in analog manner.

In this manner, both the video/audio signals received by the digital-type tuner module 120 and the video/audio signals received by the analog-type tuner module mentioned above, within the broadcast receiving apparatus mentioned above, thereafter they are selected to be one through a switch SW1, and it is converted into a predetermined format through a format convert 127, to be outputted to and displayed on so-called the flat panel display (FPD) 200, such as, the plasma display or the liquid crystal display, etc. Or, as is shown in the figure, those video/audio signals are outputted to analog-type external equipment, such as, a CRT, VCR, etc., for example; thereby, being recordable on those external equipments. However, herein, the video signal, which is converted into the predetermined format in the MPEG decoder 126 mentioned above, is further outputted, being converted into the so-called NTSC format through a NTSC encoder 128. Also, the audio signal thereof is converted into an analog audio signal through a D/A converter 129, to be outputted.

Also, in FIG. 4 mentioned above, within the broadcast receiving apparatus 100 is provided a CPU (Central Processor Unit) 130, wherein the CPU executes various kinds of processes in accordance with programs memorized within a ROM 131. For example, it controls the digital tuner 121, the QPSK decoder circuit 122, the error correction circuit 123, building up the digital tuner module, and the analog tuner module mentioned above, etc. Also, the apparatus has an IR transmitter portion 135 for generating or transmitting an infrared control signal, and the CPU 130 mentioned above outputs a predetermined control signal to other AV equipments through this IR transmitter portion, or receives the control signal from the other AV equipments.

To this CPU 130, various instructions can be also inputted, directly, through operating upon the various kinds of buttons provided on a front panel 136 of the apparatus. There is also prepared a so-called remote controller 140, other than this, and therefore the various instructions can also be inputted through operating the various kinds of buttons on that remote controller. This input signal is emitted from the IR transmitter portion 132, which is provided at a tip portion of the remoter controller, in the form of an infrared beam. And, this input signal is inputted into the CPU 130. Thus, it is also possible to input a predetermined instruction to the CPU, through operating that remote controller.

And, in FIG. 4 mentioned above, further within the broadcast receiving apparatus 100 is built a hard disk drive (i.e., the HDD) 300, for recoding the contents programs (i.e., the video/audio information). However, the data to be recorded within this HDD 300 are obtained, by conducting compression upon the video/audio signals, which are decoded within the MPEG decoder 126 mentioned above, again, within an MPEG encoder 151 in the form of digital data, and thereafter, they are recorded within the HDD 300 through a HDD processor circuit 152 for performing the recording of data through execution of predetermined recording processes. Also, as is indicated by arrows in the figure, in case where the video/audio signals decoded within the MPEG decoder 126 are inputted, directly into that HDD processor circuit 152, and also when reproducing the information that is recorded once, then the compression signals read out from the HDD 300 mentioned above are inputted into the MPEG decoder 126, again, through that HDD processor circuit 152. Thus, the decoding process (i.e., decoding) is conducted upon the video/audio signals, and the decoded video/audio signals are converted into a predetermined format through the format convert 127, and are outputted into the flat panel display (i.e., FPD) 200, to be reproduced, or are outputted into the external equipment, such as, the VCR, DVD recorder, etc. However, in this figure, a mark SW2 depicts a switch, provided for selecting either one of, the video/audio signals outputted from the analog tuner module mentioned above or the video/audio signal, which is received and converted within the MPEG decoder 126 mentioned above.

Also, as is apparent from the figure, within the broadcast receiving apparatus 100, there is further provided so-called digital information recording apparatus, such as, a DVD recorder 170, for example; therefore, the compression signal read out from the HDD 300 mentioned above can be recorded onto a DVD disk 171, which is inserted into the DVD recorder 170, through that HDD processor circuit 152. Moreover, a terminal is provided for outputting a signal read out from the HDD 300 to such the external digital recording apparatus, extending from the processor circuit 152.

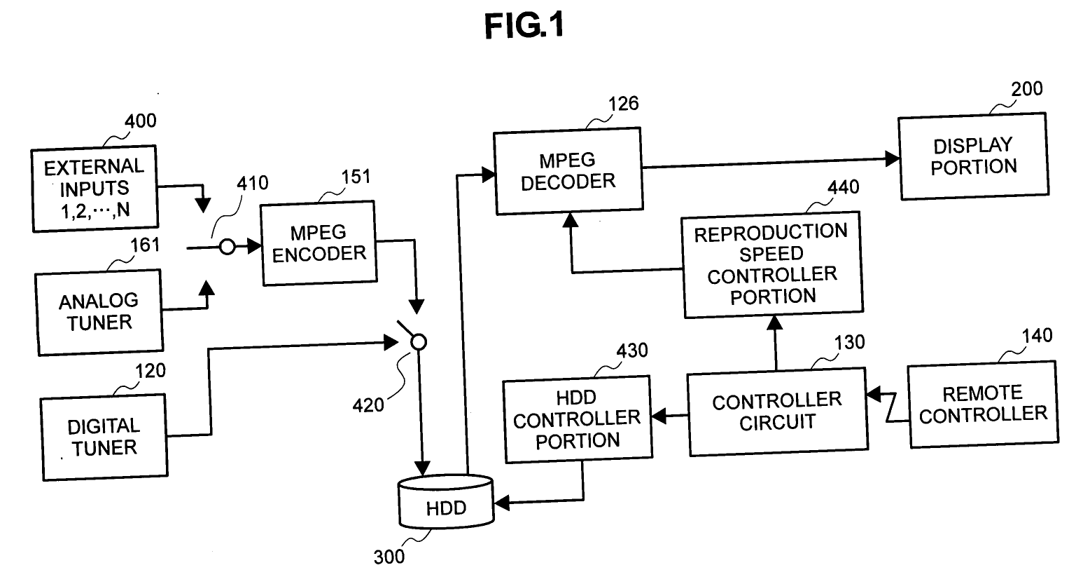

Next, the detailed structures will be shown in FIG. 1 attached herewith, of a portion surrounding the HDD 300, in particular, for achieving the “slow playback” function within the broadcast receiving apparatus 100 according to the present invention, picking up from the detailed structures thereof, which are explained in the above. Thus, as is apparent from the figure, external inputs (1, 2 . . . , N) 400 or the video/audio signal from the analog tuner 161 are selectively guided into the MPEG encoder 151 through a switch 410; thereby producing video/audio stream data. Then, the video/audio stream data from the MPEG encoder 151 or the digital tuner 120 is recorded onto the HDD 300 mentioned above, selectively through another switch 420, by means of a pickup (i.e., a magnetic head) not shown in the figure.

On the other hand, the video/audio stream data, which is recorded onto the HDD 300 once, is also reproduced by the pickup (i.e., the magnetic head), and is decoded within the MPEG decoder 126, to be converted into the predetermined format. Thereafter, it is outputted to, for example, the flat panel display (i.e., the FPD) 200, which builds up the display portion thereof, to be displayed thereon. However, in this instance, as is shown in FIG. 1 mentioned above, the HDD controller portion 430 controls a reproduction speed of the data supplied from the HDD 330 mentioned above, and further the reproduction speed within the MPEG decoder 126 mentioned above through a reproduction speed controller portion 440. However, those HDD controller portion 430 and reproduction speed controller portion 440 are controlled through a controller circuit, which is built up with the CPU 130 mentioned above. Also, for example, a “slow button” is provided on the remote controller 140 mentioned above or the front panel on the main body of the apparatus mentioned above, for executing or indicating the “slow playback” function. Furthermore, this button is made from, for example, a toggle-type button; i.e., the pushdown thereof indicates the “slow playback” function, and further another pushdown release it.

Namely, with such the structures as was mentioned above, a user can starts up the above-mentioned “slow playback” function, by pushing down the “slow button” on the remote controller 140, for example. With this, the video/audio signal inputted from the tuner mentioned above or the external input is recorded, once, onto the HDD 300 in the form of video/audio stream data, and thereafter, the “slow playback” is started from that HDD 300. When performing the “slow playback” from that HDD 300, the reproduction speed of the HDD and the reproduction speed of the video/audio within the MPEG decoder 126 are changed into a mode slower than the normal speed. In this manner, within the broadcast receiving apparatus 100 according to the present invention, the “slow playback” function is achieved, by changing (i.e., lowering) the reproduction speed after once recoding the video/audio stream data onto the HDD 300 mentioned above.

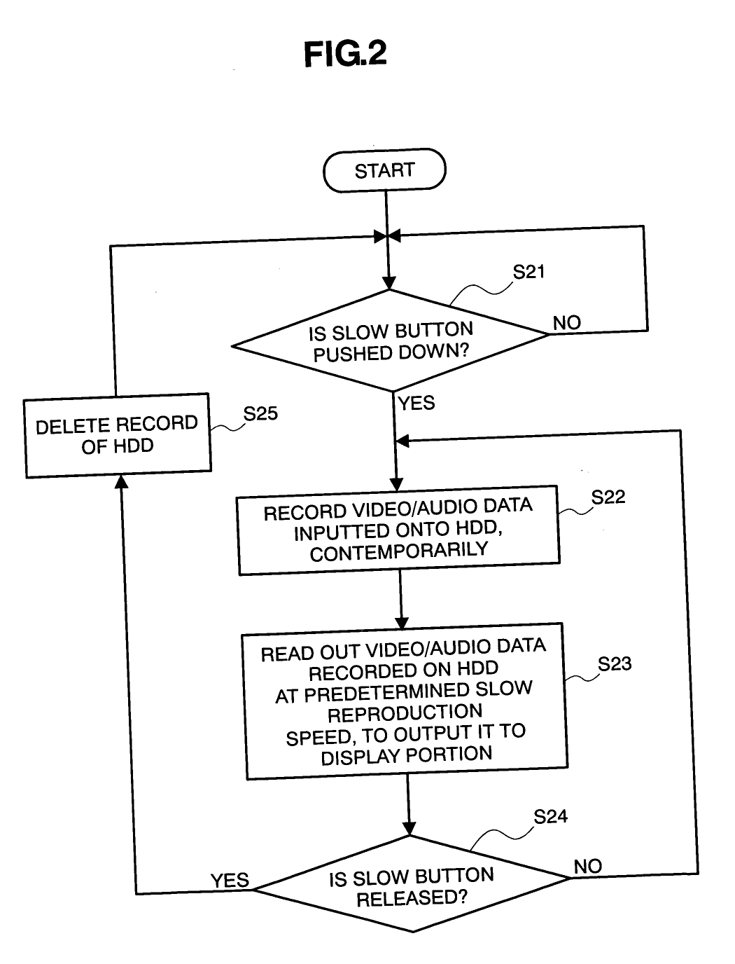

Next, the operation in the “slow playback” will be explained, which is achieved with such the structure of the broadcast receiving apparatus 100 shown in FIG. 1 mentioned above, by referring to FIG. 2 attached herewith.

First, determination is repeated on whether the “slow button” on the remote controller 140 or the front panel 136 is pushed down or not (step S21), and as a result thereof, in case when determining that the button is pushed down (“Yes” in the figure), the video/audio signal inputted from the tuner or the external input mentioned above is recorded onto the HDD 300 mentioned above, once, in the form of video/audio stream data (step S22). Thereafter, the video/audio data recorded on the HDD 300 in the above is read out at a predetermined low reproduction speed, which will be explained in more details in below, to be outputted onto the display portion.

In more details, the video data, which is read out at that low reproduction speed to be reproduced, is reproduced into the video signal, in a mode slower than an ordinary or normal one, within the MPEG decoder 126 mentioned above, and further, the vide signal is converted into the predetermined format displaceable (please refer the format converter 127 or the NTSC encoder 128 shown in FIG. 4); thereby being displayed on the flat panel display (i.e. the FPD) 200 mentioned above, while the audio signal is converted into the analog signal (please refer the D/A converter 129 shown in FIG. 4), to be outputted as sounds or voices through the built-in speaker (step S23).

Upon this, if pushing down the “slow button”, so as to execute the “slow playback” function, then the video/audio data, which was recorded once onto the HDD 300 mentioned above, is reproduced at the reproduction speed slower than the normal reproduction speed. However, in that instance, i.e., in case when lowering (slowing down) the reproduction speed, a distance between each sound is extended too much if the speed comes down to be low too much. Experimentally, it is acknowledged that the voices, in particular, including conversations, etc., comes to be difficult to listen to.

Then, various experiments are made about the reproduction speeds, being slower (i.e., lower) than the normal one, by seven (7) peoples, including the inventors of the present invention, and thereby obtaining the result shown in the following Table 1.

TABLE 1

| | X0.65 | X0.7 | X0.75 | X0.8 | X0.85 | X0.9 | X0.95 |
|---|---|---|---|---|---|---|---|
| | speed | speed | speed | speed | speed | speed | speed |
| Tester 1 | 1 | 1 | 2 | 3 | 4 | 5 | 5 |
| Tester 2 | 1 | 2 | 3 | 3 | 4 | 5 | 5 |
| Tester 3 | 1 | 1 | 2 | 3 | 4 | 5 | 5 |
| Tester 4 | 1 | 2 | 2 | 3 | 4 | 5 | 5 |
| Tester 5 | 1 | 1 | 2 | 3 | 3 | 5 | 5 |
| Tester 6 | 1 | 1 | 2 | 3 | 3 | 5 | 5 |
| Tester 7 | 1 | 1 | 3 | 3 | 3 | 5 | 5 |

Where, “1” to “5”, shown on the above Table 1, indicate the conditions (i.e., the conditions of listening to the voices) when they listen to the voices in news or English conversations, for example, while reproducing slowly at various reproduction speeds shown in the uppermost column of the table, in the form of the numerical values. In more details, they indicate:
“1”: too slow;
“2”: a little bit slow;
“3”: good;
“4”: a little bit fast; and
“5”: too fast (almost same to that of the normal reproduction), respectively.

In this manner, as a result of the experiments mentioned above, when the reproduction speed comes down to be equal to or lower than X0.75 speed, as is apparent from the Table 1 mentioned above, it can be seen that the voices are difficult to be listened due to being slow too much. On the other hand, when it is equal to or higher than X0.85 speed, the voices reproduced comes to be the same to that of the normal reproduction; thus, in spite of conducting the slow reproduction with much effort, but it is impossible to find that effort. As a result of those, there is obtained a conclusion that, the speed of that slow reproduction should be determined, preferably, within a range (an allowable setup region) from X0.75 to X0.85 speed, with respect to the normal reproduction speed, and further, more preferably, at the reproduction speed of X0.8, especially.

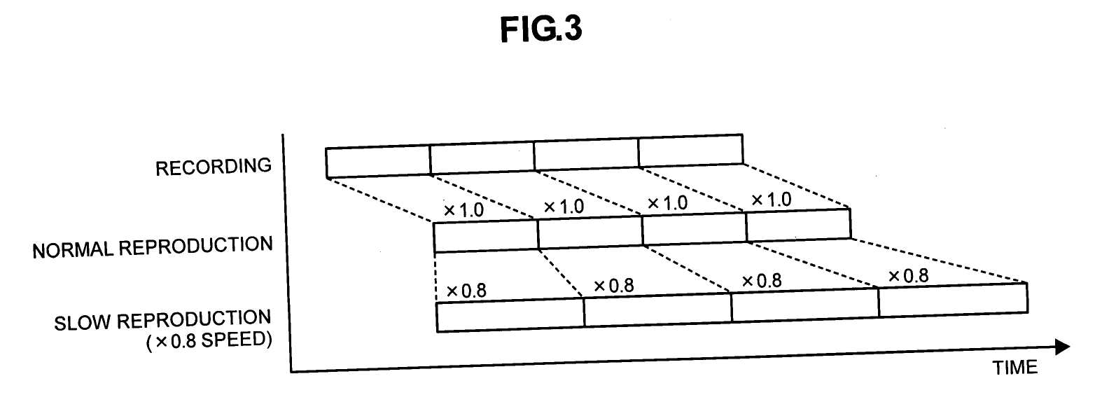

Thus, according to the present invention, as was mentioned above, upon basis of the listening examination that is actually made on the various reproduction speeds, the reproduction is executed in the step S22 mentioned above, at the reproduction speed within the allowable setup region, i.e., from X0.75 to X0.85 speed comparing to the normal reproduction speed, when reproducing the video/audio signal from the bit-stream data thereof within the MPEG decoder 126 mentioned above. Further, in FIG. 3 attached herewith, there is shown a relationship of the processes, with respect to the passage of time, in particular, about the normal reproduction (×1.0 (X1.0 speed)) and the slow reproduction (×0.8 (X0.2 speed)) in the step 22 mentioned above, after the recording of the video/audio signal in the step 21 mentioned above. Also, as is apparent from the figure, the speed when recording the video/audio signal and the speed when conducting the normal reproduction are same (×1.0), to each other.

Thereafter, the process shown in FIG. 2 further determines on whether the release of the “slow button” (i.e., second pushdown) is done or not (in step S24). As a result of this, if the stoppage of the “slow playback” function is instructed (see “Yes” in the figure), then the bit-stream data is deleted, which is recorded on the HDD 300 mentioned above, temporally (in step S25), and the process turns back to the step S21 mentioned above, to wait for the pushdown of the slow button. On the other hand, when determining that the release of the slow button is not done, in the step S24 mentioned above, then the step turns back to the steps S22 and S23, again, thereby repeating the processes mentioned above.

Further, in addition thereto, but not explain the details thereof, it is also possible to change or alter the reproduction speed, during the time-period when executing the “slow playback” function (for example, X1.0 speed→X0.8 speed→X1.0 speed); however, it is also important to set or determine the preproduction speed within the allowable setup region of from X0.75 to X0.85 speed, with respect to the normal reproduction speed, as was mentioned above. And, further, since the video/audio signal is recorded on the HDD, once, when executing the “slow playback” function, it is also possible to perform the fast-forward/return, etc., through the operation by the user. It is also possible to use the time-shift function mentioned above in common with.

As was mentioned above, with the broadcast receiving apparatus 100 mentioned above, in particular, the circuit construction for achieving the “slow playback” function shown in FIG. 1 mentioned above, it is possible to obtain superior effects, with fully using the information recording medium (i.e., the HDD) of large capacity, which is installed within the apparatus with much effort, effectively; i.e., achieving the “slow playback” function, enabling to project the video and also the audio in a slow mode, as well as, the time-shift function, which was already practiced in various kinds of products, thereby improving the usability of the broadcast receiving apparatus for the user.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A receiving apparatus, comprising:
a tuner which receives a program;
a receiving signal converter for a signal from said tuner portion into a predetermined format;
a recorder which records the signal converted by means of said receiving signal conversion portion; and
an output portion which outputs a video/audio signal from either one of said tuner and said recorder, whereby receiving the program and enabling to record and reproduce the video/audio signal, further comprising,
a function portion which reproduce the video/audio signal of said program at a speed, being lower than a speed when conducting a normal reproduction thereon and further being set within an allowable setup region of causing no trouble in reproduction of an audio, which is set in advance, when reproducing the video/audio signal to be outputted.

2. The receiving apparatus, as described in the claim 1, wherein said allowable setup region set in advance is within a region from 0.75 time to 0.85 time, with respect to a speed when conducting the normal reproduction thereon.

3. The receiving apparatus, as described in the claim 2, wherein the speed when reproducing said video/audio signal is set to be 0.8 time of the speed when conducting the normal reproduction thereon.

4. The receiving apparatus, as described in the claim 1, wherein said recorder is constructed with a hard disk apparatus.

5. The receiving apparatus, as described in the claim 1, further comprising a unit which starts a reproduction function of said video/audio signal of the program at a low speed.

6. The receiving apparatus, as described in the claim 5, wherein said unit which starts the slow-speed reproduction function is provided in a portion of a main body of said apparatus, or a portion of a body separated from said main body.

7. The receiving apparatus, as described in the claim 1, wherein said output portion includes a screen for displaying the vide signal thereon and a speaker for reproducing the audio signal.

8. An information reproducing method for use of a receiving apparatus, for recoding/reproducing video/audio information of a program, onto a recorder of being recordable and reproducible of information, which is built within the apparatus, thereby enabling to reproduce the video/audio information, wherein the video/audio signal of said program is reproduced at a speed, being lower than a speed when conducting a normal reproduction thereon and further being set within an allowable setup region of causing no trouble in reproduction of an audio, which is set in advance, when reproducing the video/audio signal.

9. The information reproducing method, as described in the claim 8, wherein said allowable setup region set in advance is within a region from 0.75 time to 0.85 time, with respect to a speed when conducting the normal reproduction thereon.

10. The information reproducing method, as described in the claim 9, wherein the speed when reproducing said video/audio signal is set to be 0.8 time of the speed when conducting the normal reproduction thereon.
